(19) United States
(12) Patent Application Publication
(10) Pub. No.: US 2014/0116893 A1
(43) Pub. Date: May 1, 2014

(54) SYSTEM AND METHOD FOR REDUCTION OF PERCEIVED INACCURACY OF ANALYTE MEASUREMENTS

(71) Applicant: LIFESCAN, INC., Milpitas, CA (US)

(72) Inventor: Eric David BERGMAN, Menlo Park, CA (US)

(73) Assignee: LifeScan, Inc., Milpitas, CA (US)

(21) Appl. No.: 13/663,251

(22) Filed: Oct. 29, 2012

(51) Int. Cl. G01N 27/26

(52) U.S. Cl. 205/782; 204/403.02

(57) ABSTRACT

Described are methods and systems to reduce or obviate complaints about “inaccuracy” of blood glucose meter which utilize an exemplary technique to distinguish between subjective and objective inaccuracies of the analyte measurements.

### BACKGROUND

Analyte detection in physiological fluids, e.g. blood or blood derived products, is of ever increasing importance to today's society. Analyte detection assays find use in a variety of applications, including clinical laboratory testing, home testing, etc., where the results of such testing play a prominent role in diagnosis and management in a variety of disease conditions. Analytes of interest include glucose for diabetes management, cholesterol, and the like. In response to this growing importance of analyte detection, a variety of analyte detection protocols and devices for both clinical and home use have been developed.

One type of method that is employed for analyte detection is an electrochemical method. In such methods, an aqueous liquid sample is placed into a sample-receiving chamber in an electrochemical cell that includes two electrodes, e.g., a counter and working electrode. The analyte is allowed to react with a redox reagent to form an oxidizable (or reducible) substance in an amount corresponding to the analyte concentration. The quantity of the oxidizable (or reducible) substance present is then estimated electrochemically and related to the amount of analyte present in the initial sample.

Such systems are allotted by regulatory bodies (such as the Food and Drug Administration and its counterparts in Europe, Japan and Canada) to have certain tolerances between referential analyte measurement and measurement made by the meter and strips. Users, not knowing the allotted tolerances in analyte measurements, believe that the meter or strip is defective due to the range of variation in measurements allotted to the system. This is believed to cause users to perceive that their glucose control is sub-optimal or that their analyte measurement system is defective.

### SUMMARY OF THE DISCLOSURE

Applicant has devised a technique to reduce or obviates many of the problems encountered by the users in using analyte measurement system noted above. In particular, applicant has devised a technique to inform the user that certain analyte measurements that are perceived to be inaccurate are in fact not the case and in instances where the meter, test strip or both meter and strip are in fact inaccurate in providing the glucose result, the user is informed and urged to contact the manufacturer of the meter for resolution.

In one aspect, a method of reducing perceived inaccurate blood analyte measurements by at least one glucose meter (which has a microcontroller) and at least one test strip is provided. The method can be achieved by: conducting an analyte measurement with at least one test strip and physiological fluid sample from a patient (who may also be the device user); ascertaining whether at least one prior analyte measurement was made within a time interval prior to the conducting step; in the event the ascertaining step indicates that the at least one prior analyte measurement was made within the time interval prior to the conducting step, determining whether the at least one prior analyte measurement is greater than the analyte measurement by a predetermined value; in the event the determining step indicates that the at least one prior analyte measurement is greater than the analyte measurement by at least the predetermined value, requesting the user to conduct another analyte measurement; and in the event the determining step indicates that the at least one prior analyte measurement is not greater than the analyte measurement by the predetermined value, annunciating to the user that analyte measurement is within expected accuracy.

In yet another aspect, an analyte meter that determines analyte level in a fluid sample with a test strip is provided. The test strip has a plurality of electrodes proximate chemical reagent disposed on the test strip. The electrodes are in electrical communication with respective electrode connectors. The meter includes a housing, a test strip port and a microprocessor. The test strip port connector is configured to connect to the respective electrode connectors of the test strip. The microprocessor is in electrical communication with the test strip port connector to apply electrical signals or sense electrical signals from the plurality of electrodes during a test sequence to provide for an analyte measurement. The microprocessor is configured to: (a) store a most recent analyte measurement and a prior analyte measurement within a predetermined time interval between the most recent and prior measurements, (b) determine if a difference between the most recent and prior analyte measurements is within a predetermined threshold, indicate that the results are within expected accuracy; or (c) if the difference is greater than the predetermined threshold, request the user to conduct another test.

In the above aspects, the following steps or features can also be utilized singly or in combination with each other for the above aspect such as, for example, by conducting another analyte measurement subsequent to the requesting step; ascertaining whether another analyte measurement was made within a time interval after the conducting step for the analyte measurement; in the event the ascertaining step indicates that the another analyte measurement was made within the time interval after to the conducting step, determining whether the another analyte measurement is greater than the analyte measurement by a predetermined value; in the event the determining step indicates that the another analyte measurement is greater than the analyte measurement by at least the predetermined value, requesting the user to contact the manufacturer or distributer of the meter; determining if the analyte measurement is about the same value as the at least one prior analyte measurement within the time interval T, and if true annunciating to the user of the value of the analyte measurement otherwise requesting another measurement test; in which the at least one glucose meter may include a first glucose meter on which the at least one prior analyte measurement was made and a second glucose meter in which the analyte measurement was made; in which the time interval T may include a time interval selected from intervals consisting essentially of five minutes, ten minutes, fifteen minutes, twenty minutes, twenty-five minutes, thirty minutes and any interval from five minutes to thirty minutes; in which the predetermined value may include a percentage error in analyte measurements from about 10%, 15% , 20%, 25%, 30% or about 40%; or in which the predetermined value may include a differential between the two measurements in terms of the analyte per dL of physiological fluid (e.g., such milligrams of glucose/deciliter of blood such as for example, 10 mg/dL, 15 mg/dL, 20 mg/dL, 25 mg/dL, 30 mg/dL, 35 mg/dL, or 40 mg/dL).

These and other embodiments, features and advantages will become apparent to those skilled in the art when taken with reference to the following more detailed description of various exemplary embodiments of the invention in conjunction with the accompanying drawings that are first briefly described.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention (wherein like numerals represent like elements).

FIG. 1A illustrates a preferred blood analyte measurement system.

FIG. 1B illustrates the various components disposed in the meter of FIG. 1A.

FIG. 1C illustrates a perspective view of an assembled test strip suitable for use in the system and methods disclosed herein;

FIG. 1D illustrates an exploded perspective view of an unassembled test strip suitable for use in the system and methods disclosed herein;

FIG. 1E illustrates an expanded perspective view of a proximal portion of the test strip suitable for use in the system and methods disclosed herein;

FIG. 2 is a bottom plan view of one embodiment of a test strip disclosed herein;

FIG. 3 is a side plan view of the test strip of FIG. 2;

FIG. 4A is a top plan view of the test strip of FIG. 3;

FIG. 4B is a partial side view of a proximal portion of the test strip of FIG. 4A;

FIG. 5 is a simplified schematic showing a test meter electrically interfacing with portions of a test strip disclosed herein;

FIG. 6 illustrates an exemplary logic to distinguish between subjective inaccuracy and objective inaccuracy of at least one blood glucose meter; and

FIG. 7 illustrates yet another system in which the logic is implemented not on the glucose meter but on a remote system to achieve the same results.

### MODES FOR CARRYING OUT THE INVENTION

The following detailed description should be read with reference to the drawings, in which like elements in different drawings are identically numbered. The drawings, which are not necessarily to scale, depict selected embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein. In addition, as used herein, the terms “patient,” “host,” “user,” and “subject” refer to any human or animal subject and are not intended to limit the systems or methods to human use, although use of the subject invention in a human patient represents a preferred embodiment.

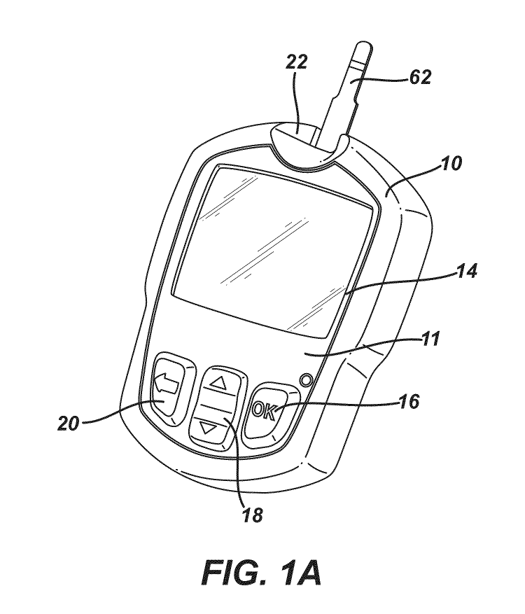

FIG. 1A illustrates a diabetes management system that includes a meter 10 and a biosensor in the form of a glucose test strip 62. Note that the meter (meter unit) may be referred to as an analyte measurement and management unit, a glucose meter, a meter, and an analyte measurement device. In an embodiment, the meter unit may be combined with an insulin delivery device, an additional analyte testing device, and a drug delivery device. The meter unit may be connected to a remote computer or remote server via a cable or a suitable wireless technology such as, for example, GSM, CDMA, BlueTooth, WiFi and the like.

Referring back to FIG. 1A, glucose meter or meter unit 10 may include a housing 11, user interface buttons (16, 18, and 20), a display 14, and a strip port opening 22. User interface buttons (16, 18, and 20) may be configured to allow the entry of data, navigation of menus, and execution of commands. User interface button 18 may be in the form of a two way toggle switch. Data may include values representative of analyte concentration, or information, which are related to the everyday lifestyle of an individual. Information, which is related to the everyday lifestyle, may include food intake, medication use, occurrence of health check-ups, and general health condition and exercise levels of an individual. The electronic components of meter 10 may be disposed on a circuit board 34 that is within housing 11.

FIG. 1B illustrates (in simplified schematic form) the electronic components disposed on a top surface of circuit board 34. On the top surface, the electronic components include a strip port connector 22, an operational amplifier circuit 35, a microcontroller 38, a display connector 14a, a non-volatile memory 40, a clock 42, and a first wireless module 46. On the bottom surface, the electronic components may include a battery connector (not shown) and a data port 13. Microcontroller 38 may be electrically connected to strip port connector 22, operational amplifier circuit 35, first wireless module 46, display 14, non-volatile memory 40, clock 42, battery, data port 13, and user interface buttons (16, 18, and 20).

Operational amplifier circuit 35 may include two or more operational amplifiers configured to provide a portion of the potentiostat function and the current measurement function. The potentiostat function may refer to the application of a test voltage between at least two electrodes of a test strip. The current function may refer to the measurement of a test current resulting from the applied test voltage. The current measurement may be performed with a current-to-voltage converter. Microcontroller 38 may be in the form of a mixed signal microprocessor (MSP) such as, for example, the Texas Instrument MSP 430. The TI-MSP 430 may be configured to also perform a portion of the potentiostat function and the current measurement function. In addition, the MSP 430 may also include volatile and non-volatile memory. In another embodiment, many of the electronic components may be integrated with the microcontroller in the form of an application specific integrated circuit (ASIC).

Strip port connector 22 may be configured to form an electrical connection to the test strip. Display connector 14a may be configured to attach to display 14. Display 14 may be in the form of a liquid crystal display for reporting measured glucose levels, and for facilitating entry of lifestyle related information. Display 14 may optionally include a backlight. Data port 13 may accept a suitable connector attached to a connecting lead, thereby allowing glucose meter 10 to be linked to an external device such as a personal computer. Data port 13 may be any port that allows for transmission of data such as, for example, a serial, USB, or a parallel port. Clock 42 may be configured to keep current time related to the geographic region in which the user is located and also for measuring time. The meter unit may be configured to be electrically connected to a power supply such as, for example, a battery.

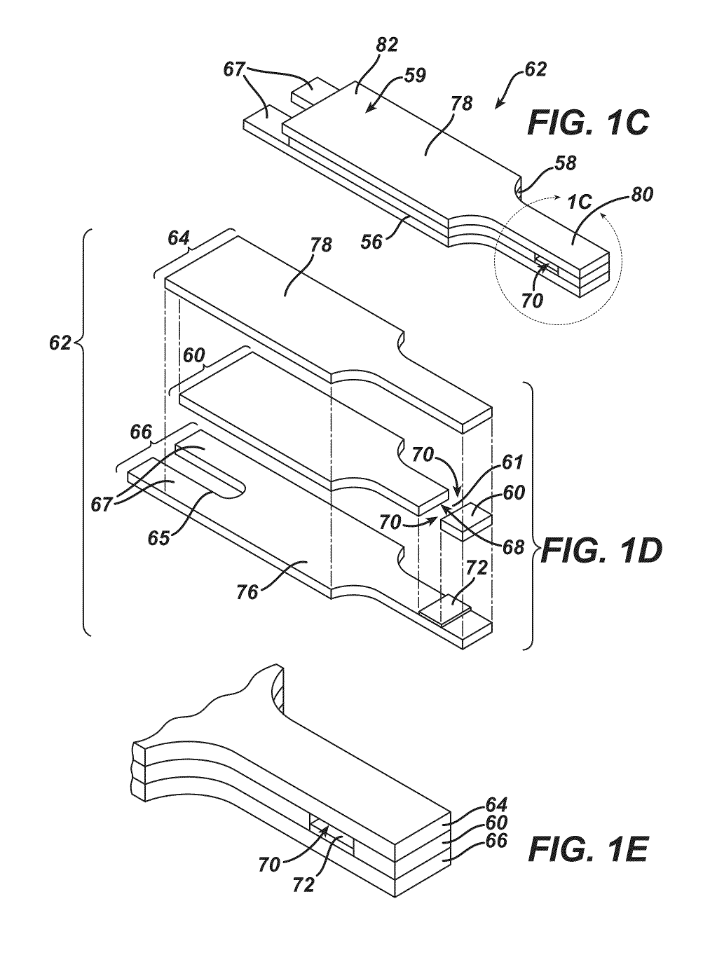

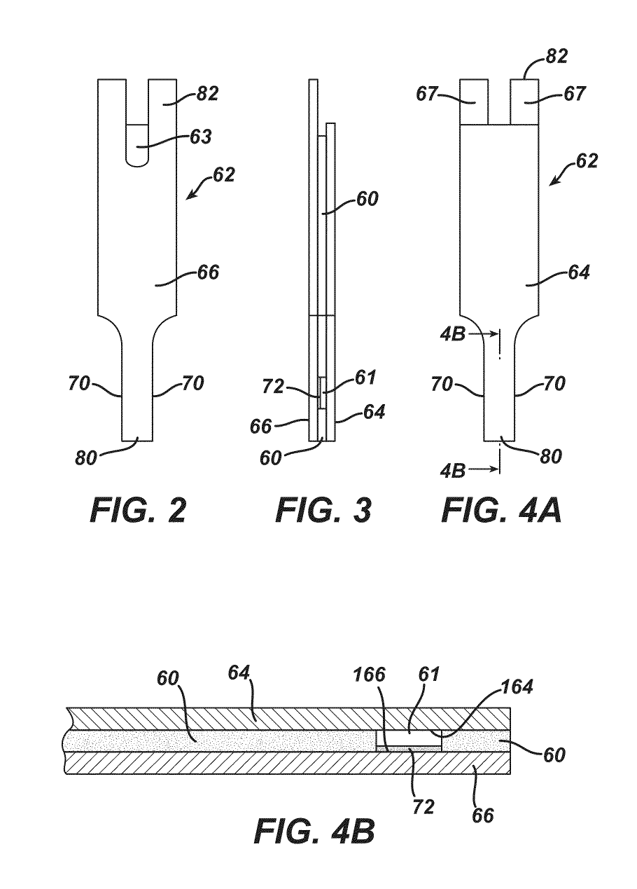

FIGS. 1C-1E, 2, 3, and 4B show various views of an exemplary test strip 62 suitable for use with the methods and systems described herein. In an exemplary embodiment, a test strip 62 is provided which includes an elongate body extending from a distal end 80 to a proximal end 82, and having lateral edges 56, 58, as illustrated in FIG. 1C. As shown in FIG. 1D, the test strip 62 also includes a first electrode layer 66, a second electrode layer 64, and a spacer 60 sandwiched in between the two electrode layers 64 and 66. The first electrode layer 66 may include a first electrode 66, a first connection track 76, and a first contact pad 67, where the first connection track 76 electrically connects the first electrode 66 to the first contact pad 67, as shown in FIGS. 1D and 4B. Note that the first electrode 66 is a portion of the first electrode layer 66 that is immediately underneath the reagent layer 72, as indicated by FIGS. 1D and 4B. Similarly, the second electrode layer 64 may include a second electrode 64, a second connection track 78, and a second contact pad 63, where the second connection track 78 electrically connects the second electrode 64 with the second contact pad 63, as shown in FIGS. 1D, 2, and 4B. Note that the second electrode 64 is a portion of the second electrode layer 64 that is above the reagent layer 72, as indicated by FIG. 4B.

As shown, the sample-receiving chamber 61 is defined by the first electrode 66, the second electrode 64, and the spacer 60 near the distal end 80 of the test strip 62, as shown in FIGS. 1D and 4B. The first electrode 66 and the second electrode 64 may define the bottom and the top of sample-receiving chamber 61, respectively, as illustrated in FIG. 4B. A cutout area 68 of the spacer 60 may define the sidewalls of the sample-receiving chamber 61, as illustrated in FIG. 4B. In one aspect, the sample-receiving chamber 61 may include ports 70 that provide a sample inlet or a vent, as shown in FIGS. 1C to 1E. For example, one of the ports may allow a fluid sample to ingress and the other port may allow air to egress.

In an exemplary embodiment, the sample-receiving chamber 61 (or test cell or test chamber) may have a small volume. For example, the chamber 61 may have a volume in the range of from about 0.1 microliters to about 5 microliters, about 0.2 microliters to about 3 microliters, or, preferably, about 0.3 microliters to about 1 microliter. To provide the small sample volume, the cutout 68 may have an area ranging from about 0.01 cm² to about 0.2 cm², about 0.02 cm² to about 0.15 cm², or, preferably, about 0.03 cm² to about 0.08 cm². In addition, first electrode 66 and second electrode 64 may be spaced apart in the range of about 1 micron to about 500 microns, preferably between about 10 microns and about 400 microns, and more preferably between about 40 microns and about 200 microns. The relatively close spacing of the electrodes may also allow redox cycling to occur, where oxidized mediator generated at first electrode 66, may diffuse to second electrode 64 to become reduced, and subsequently diffuse back to first electrode 66 to become oxidized again. Those skilled in the art will appreciate that variations of the volumes, areas, or spacing of electrodes are within the spirit and scope of the present disclosure.

In one embodiment, the first electrode layer 66 and the second electrode layer 64 may be a conductive material formed from materials such as gold, palladium, carbon, silver, platinum, tin oxide, iridium, indium, or combinations thereof (e.g., indium doped tin oxide). In addition, the electrodes may be formed by disposing a conductive material onto an insulating sheet (not shown) by a sputtering, electroless plating, or a screen-printing process. In one exemplary embodiment, the first electrode layer 66 and the second electrode layer 64 may be made from sputtered palladium and sputtered gold, respectively. Suitable materials that may be employed as spacer 60 include a variety of insulating materials, such as, for example, plastics (e.g., PET, PETG, polyimide, polycarbonate, polystyrene), silicon, ceramic, glass, adhesives, and combinations thereof. In one embodiment, the spacer 60 may be in the form of a double sided adhesive coated on opposing sides of a polyester sheet where the adhesive may be pressure sensitive or heat activated. Applicants note that various other materials for the first electrode layer 66, the second electrode layer 64, or the spacer 60 are within the spirit and scope of the present disclosure.

Either the first electrode 66 or the second electrode 64 may perform the function of a working electrode depending on the magnitude or polarity of the applied test voltage. The working electrode may measure a limiting test current that is proportional to the reduced mediator concentration. For example, if the current limiting species is a reduced mediator (e.g., ferrocyanide), then it may be oxidized at the first electrode 66 as long as the test voltage is sufficiently greater than the redox mediator potential with respect to the second electrode 64. In such a situation, the first electrode 66 performs the function of the working electrode and the second electrode 64 performs the function of a counter/reference electrode. Applicants note that one may refer to a counter/reference electrode simply as a reference electrode or a counter electrode. A limiting oxidation occurs when all reduced mediator has been depleted at the working electrode surface such that the measured oxidation current is proportional to the flux of reduced mediator diffusing from the bulk solution towards the working electrode surface. The term “bulk solution” refers to a portion of the solution sufficiently far away from the working electrode where the reduced mediator is not located within a depletion zone. It should be noted that unless otherwise stated for test strip 62, all potentials applied by test meter 10 will hereinafter be stated with respect to second electrode 64.

Similarly, if the test voltage is sufficiently less than the redox mediator potential, then the reduced mediator may be oxidized at the second electrode 64 as a limiting current. In such a situation, the second electrode 64 performs the function of the working electrode and the first electrode 66 performs the function of the counter/reference electrode.

Initially, an analysis may include introducing a quantity of a fluid sample into a sample-receiving chamber 61 via a port 70. In one aspect, the port 70 or the sample-receiving chamber 61 may be configured such that capillary action causes the fluid sample to fill the sample-receiving chamber 61. The first electrode 66 or second electrode 64 may be coated with a hydrophilic reagent to promote the capillarity of the sample-receiving chamber 61. For example, thiol derivatized reagents having a hydrophilic moiety such as 2-mercaptoethane sulfonic acid may be coated onto the first electrode or the second electrode.

In the analysis of strip 62 above, reagent layer 72 can include glucose dehydrogenase (GDH) based on the PQQ co-factor and ferricyanide. In another embodiment, the enzyme GDH based on the PQQ co-factor may be replaced with the enzyme GDH based on the FAD co-factor. When blood or control solution is dosed into a sample reaction chamber 61, glucose is oxidized by GDH₍ₒₓ₎ and in the process converts GDH₍ₒₓ₎ to GDH_{(red)}, as shown in the chemical transformation T.1 below. Note that GDH₍ₒₓ₎ refers to the oxidized state of GDH, and GDH_{(red)} refers to the reduced state of GDH.

D-Glucose+GDH₍ₒₓ₎ Gluconic acid+GDH_{(red)} T.1

Next, GDH_{(red)} is regenerated back to its active oxidized state by ferricyanide (i.e. oxidized mediator or Fe (CN)₆³⁻) as shown in chemical transformation T.2 below. In the process of regenerating GDH₍ₒₓ₎, ferrocyanide (i.e. reduced mediator or Fe(CN)₆⁴⁻) is generated from the reaction as shown in T.2:

GDH_{(red)+}2Fe(CN)₆³⁻ GDH₍ₒₓ₎₊2Fe(CN)₆⁴⁻ T.2

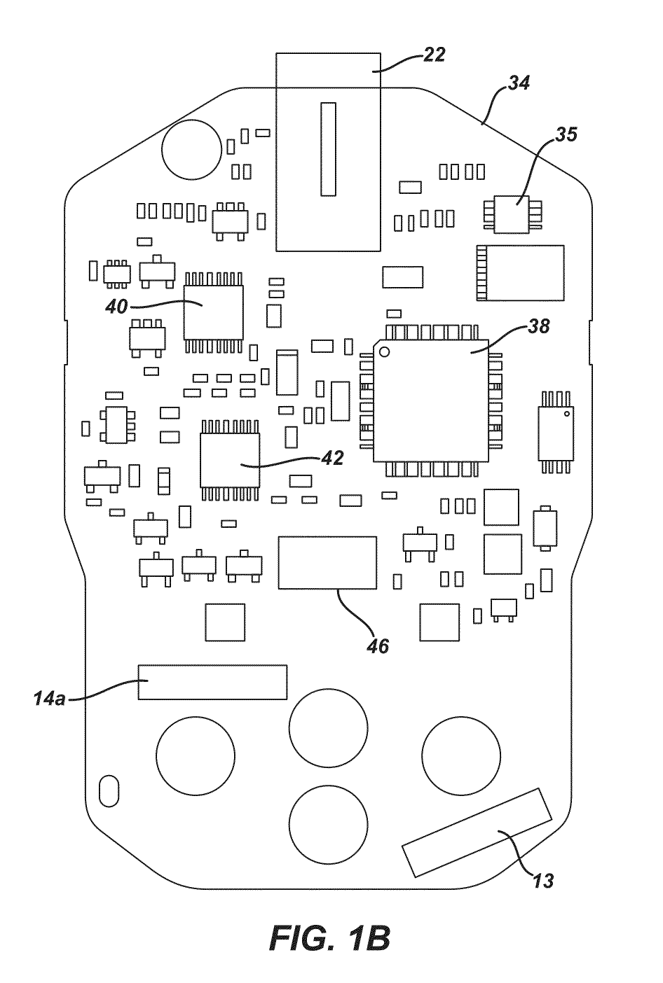

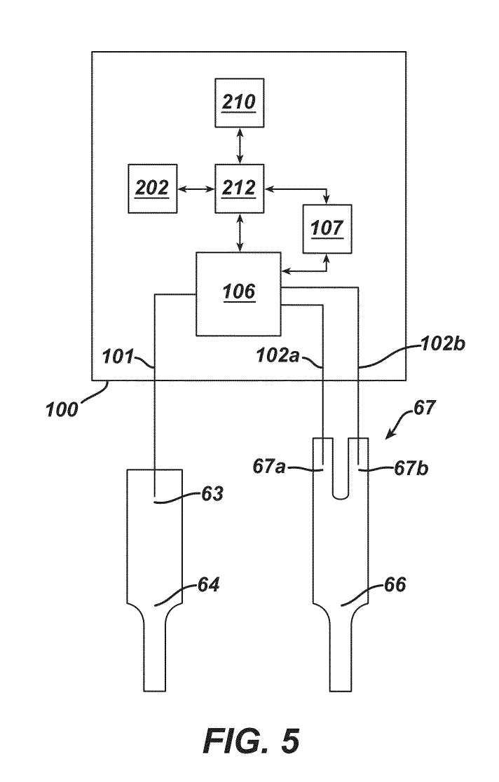

FIG. 5 provides a simplified schematic showing a test meter 100 interfacing with a first contact pad 67a, 67b and a second contact pad 63. The second contact pad 63 may be used to establish an electrical connection to the test meter through a U-shaped notch 65, as illustrated in FIG. 2. In one embodiment, the test meter 100 may include a second electrode connector 101, and a first electrode connectors (102a, 102b), a test voltage unit 106, a current measurement unit 107, a processor 212, a memory unit 210, and a visual display 202, as shown in FIG. 5. The first contact pad 67 may include two prongs denoted as 67a and 67b. In one exemplary embodiment, the first electrode connectors 102a and 102b separately connect to prongs 67a and 67b, respectively. The second electrode connector 101 may connect to second contact pad 63. The test meter 100 may measure the resistance or electrical continuity between the prongs 67a and 67b to determine whether the test strip 62 is electrically connected to the test meter 10. The electrodes 64 and 66 here can be utilized to detect physical characteristics of the sample using alternating signals. Alternatively, separate additional electrodes can be provided in the test chamber to allow for detection of the physical characteristics of the sample using alternating signals.

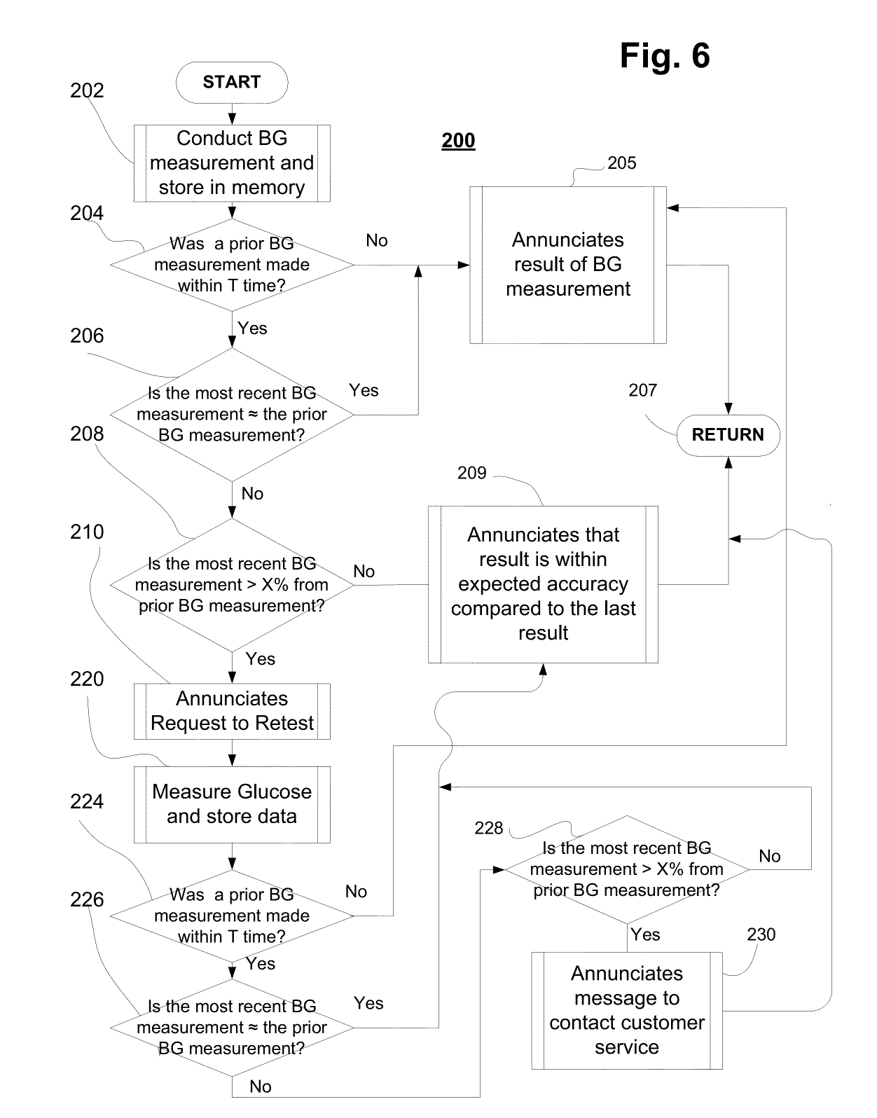

Referring to FIG. 6, applicant has realized that one of the most frequent patient complaints to glucose meter manufacturers are complaints about “inaccuracy” of the meter. There are a number of causes, but it appears that the majority of such complaints are not in response to actual inaccuracy, but rather perceived inaccuracy based on a subjective feel of the user. It is believed that the reason for this is because although differences from the given error range with respect to actual analyte level as measured by a standard laboratory analyzer such as Yellow Springs Instrument (YSI). As an example, in the manufacturing of the test strip and meter described herein (marketed as LifeScan One-Touch Verio system) the normal and expected error is YSI±15%, which is considered to be normal and expected. Likewise, another test strip (marketed as LifeScan One-Touch Ultra system), the expected error is YSI±20%. Nevertheless, these differences were often not expected by patients. Indeed, because specifications for strip accuracy are defined relative to YSI, this means that even larger differences can occur between two analyte measurements on a meter even when taken close together. This means that analyte measurement (“BG”) differences between two test strip measurements that are much less than the expected/allowable range may trigger concern for patients, especially if results span values perceived to be quite different even if the percentage difference is not unusual (e.g., a glucose measurement of 103 mg/dL followed by a measurement of 87 mg/dL).

One scenario, likely responsible for many tens of thousands of support calls each year is that the patient performs two tests within a short time interval (such as 5 minutes). The users would obtain two results that while meeting a manufacturer's requirements for strip performance/accuracy, but that are at odds with the users' expectations. As a result, they contact the manufacturers or distributors based on a subjective perception that is at odds with the technical requirements for such test strips. In other words, the patient or user perceives that the meter system and/or strip is not functioning properly because results obtained in successive testing appear very different (to them) but yet well within the manufacturer's specification. The consequences of this misunderstanding can include wasted patient time, potential patient emotional distress, and costs to the meter manufacturers in support time and resources.

Recognizing this, applicant seeks to mitigate the frequency of perceived inaccuracy by reducing the likelihood that a patient will reach a level of misunderstanding that would motivate them to contact the manufacturer or distributor. On the flip side, applicant seeks to increase the likelihood patients will contact the meter manufacturer in the event of an actual inaccuracy. Consequently, applicant has devised this invention in order to achieve the objectives set forth herein.

Specifically, as shown in FIG. 6, applicant's exemplary technique 200 begins with step 202 in which at least one glucose meter and at least one test strip is utilized by the user to conduct an analyte measurement with the at least one test strip and physiological fluid sample from the user. At step 204, the method ascertains whether at least one prior analyte measurement was made within a time interval T prior to the conducting step 202. In the event the ascertaining step 204 indicates that the at least one prior analyte measurement was made within the time interval T prior to the conducting step, the method, at step 206 determines whether the most recent analyte measurement is about the same magnitude as the prior analyte measurement. If true, the logic moves to step 205 whereby the most recent analyte measurement is annunciated to the user. Thereafter, the logic returns to the main routine. On the other hand, if the query at step 206 is not true then the logic moves to step 208, to determine whether the at least one prior analyte measurement is greater than the analyte measurement by a predetermined value such as for example, a percentage differential from the prior measurement or in absolute magnitude. If the query at step 208 is true, that is, in the event step 208 indicates that the at least one prior analyte measurement is greater than the most recent analyte measurement by at least the predetermined value (or for example, by percentage error or in absolute magnitude), then the logic moves to step 210 requesting the user to conduct another analyte measurement. However, if the query at step 208 returns a false, meaning that that the at least one prior analyte measurement is not greater than the analyte measurement by the predetermined value then the logic moves to step 209 and a message is annunciated to the user to indicate that the most recent result and prior result(s) are within the manufacturer's expected accuracy range.

In the embodiments provided herein a time interval T can be selected from intervals such as, for example, five minutes, ten minutes, fifteen minutes, twenty minutes, twenty-five minutes, thirty minutes or any interval from five minutes to sixty minutes. In the preferred embodiments, the time interval T may be set to be about 5 minutes, 10 minutes, or 15 minutes. Moreover, the percentage accuracy can be set to be about 5% to about 40% or, in terms of absolute magnitude 15 mg/dL to 40 mg/dL. For percentage error, the logic can take a difference of the most recent measurement and the prior measurement that are within time interval T and divide the difference by the most recent result (or the prior result) multiplied by 100 to give an approximation of percentage error. And as used here, the term “annunciated” or “annunciating” and variations on this root term indicate that an announcement may be provided via text, audio, visual or a combination of all modes of communication to a user.

In the scenario where the query at step 208 returns an indication that the most recent analyte measurement is greater by certain threshold than the prior analyte measurement, the system not request that the user performs another test, the system begins a secondary check of the meter by performing yet another range accuracy check in steps 224-226 (similar to steps 204-210) and 228 before concluding that the meter may need to be serviced at step 230.

Applicant notes that this invention can be applied to a related but different scenario in which the patient performs two tests within a short time interval on two different meters. However, in order to support that scenario, both meters have wireless communication (Bluetooth, Wi-Fi or the like) and an algorithm running on one or both respective processors of the two meters to “recognize” the other meter and communicate with it over the wireless protocol in order to carry out technique 200. Yet another approach is to support manual entry of values by the users in the meter. In other words, the meter may provide a series of questions and choices that lets the user compare test results within a time period. When the user selects this function, the meter prompts them for the results and the time interval between results. The meter can then tell the user if the results indicate that the meter (or meters) is accurate or not based on information (results and time interval) the user provided. This approach also can be implemented on a web site by having the logic 200 configured with a series of questions and choices so that the glucose results can be analyzed in accordance with logic 200.

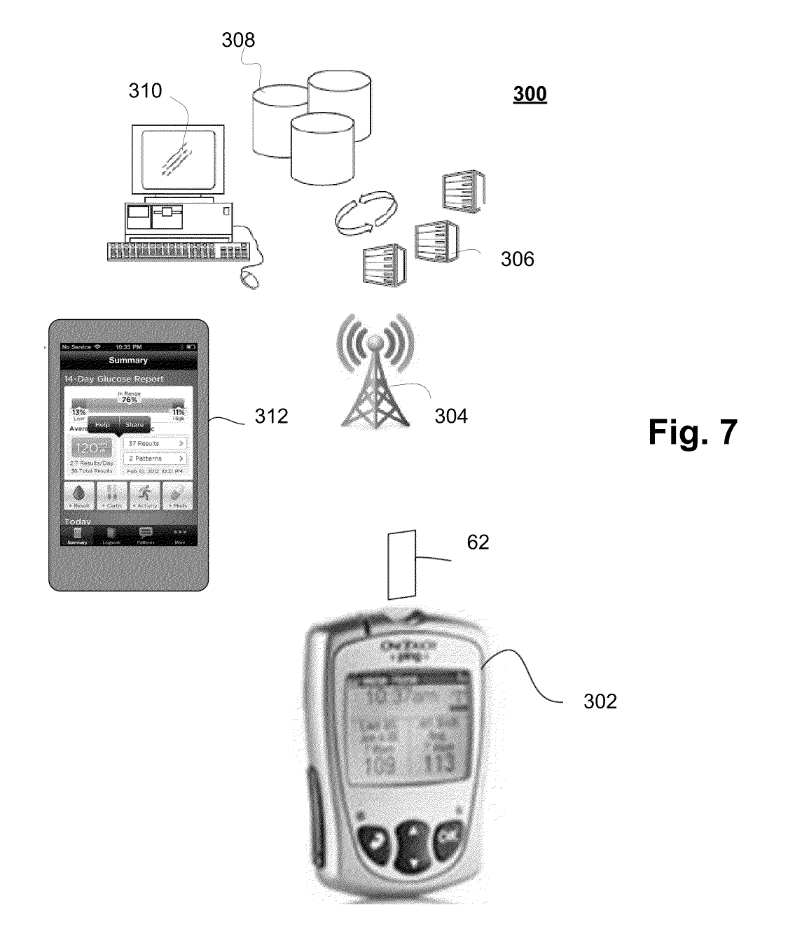

It is noted that while the method has been described in relation to at least one meter, the invention can also be utilized with a diabetes management system (“DMS”) in which glucose related data of the meter(s) can be uploaded into the DMS for real-time or subsequent analysis of the results with a PC 310 or mobile computing device 312. For example, as shown in system 300 of FIG. 7, a glucose meter 302 is connected in real-time to the DMS via a network (e.g., LAN or internet) through network infrastructure 304, the DMS can utilize the methodology (embedded into server 306, stored in remote memory or executed on a remote computer 310) to determine if there is a problem with the meter 302 or strip 62 relating to accuracy. Alternatively, the system 300 can also analyze the data retrospectively to determine if there is an accuracy problem with the meter(s) and inform the user or healthcare provider of the same.

Referring back to FIG. 7, instead of having the meter collect the analyte measurements in order to perform the analysis in FIG. 6, the logic 200 can also be implemented in a server 306 or in the computer 310 to allow the user to type in or enter (via voice command) a first measurement and a second measurement within a given time interval so that the logic 200 (embedded in server 306 (rendering the logic 200 web-based) or PC 310) can be used to tell the user if the numbers were accurate or not with respect to the manufacturer's or regulatory specification. One advantage to this would be to allow the users to check accuracy of older meters that may not have this logic programmed into such meter. Another advantage would be to allow for a comparison across separate but older meters which do not have the logic 200 programmed or embedded into its software. In yet another variation, the logic 200 can also be programmed into a mobile phone, Smartphone (e.g., iPhone) or tablet (i.e., mobile computing device 312 such as an iPad). Further, this invention can also be applied to post-hoc analysis of test results that have been stored in the meter with PC 310 or device 312. Alternatively, retrospective analysis in accordance with the teachings of the invention can also be obtained for glucose data downloaded into a diabetes management software or one running on a cloud based diabetes management system.

Applicant notes that while the exemplary description and figures are to glucose meters and glucose test strips, it is the intention of applicant that the invention is equally applicable to any analyte measurement system, such as, for example, cholesterol, ketone, and similar analytes in physiological fluid such as, for example, sweat, interstitial fluid or blood and the like.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

What is claimed is:

1. A method of reducing perceived inaccurate blood analyte measurements by at least one glucose meter and at least one test strip, the method comprising:
conducting an analyte measurement with the at least one test strip and physiological fluid sample from a user;
ascertaining whether at least one prior analyte measurement was made within a time interval prior to the conducting step;
in the event the ascertaining step indicates that the at least one prior analyte measurement was made within the time interval prior to the conducting step, determining whether the at least one prior analyte measurement is greater than the analyte measurement by a predetermined value;
in the event the determining step indicates that the at least one prior analyte measurement is greater than the analyte measurement by at least the predetermined value, requesting the user to conduct another analyte measurement; or
in the event the determining step indicates that the at least one prior analyte measurement is not greater than the analyte measurement by the predetermined value, annunciating to the user that analyte measurement is within expected accuracy.

2. The method of claim 1, further comprising:
conducting another analyte measurement subsequent to the requesting step;
ascertaining whether another analyte measurement was made within a time interval after the conducting step for the analyte measurement;
in the event the ascertaining step indicates that the another analyte measurement was made within the time interval after to the conducting step, determining whether the another analyte measurement is greater than the analyte measurement by a predetermined value;
in the event the determining step indicates that the another analyte measurement is greater than the analyte measurement by at least the predetermined value, requesting the user to contact the manufacturer or distributer of the meter.

3. The method of claim 1, further comprising the step of determining if the analyte measurement is about the same value as the at least one prior analyte measurement within the time interval T, and if true annunciating to the user of the value of the analyte measurement otherwise requesting another measurement test.

4. The method of claim 1, in which the at least one glucose meter comprises a first glucose meter on which the at least one prior analyte measurement was made and a second glucose meter in which the analyte measurement was made.

5. The method of claim 1, in which the time interval T comprises a time interval selected from intervals consisting essentially of five minutes, ten minutes, fifteen minutes, twenty minutes, twenty-five minutes, thirty minutes and any interval from five minutes to thirty minutes.

6. The method of claim 1, in which the predetermined value comprises a percentage error in analyte measurements from about 10%, 15% , 20%, 25%, 30% or about 40%.

7. The method of claim 1, in which the predetermined value comprises a differential between the two measurements of about 10 mg/dL, 15 mg/dL, 20 mg/dL, 25 mg/dL, or 30 mg/dL.

8. An analyte meter that determines analyte level in a fluid sample with a test strip having a plurality of electrodes proximate chemical reagent disposed on the test strip, the electrodes in electrical communication with respective electrode connectors, the meter including:
a housing;
a test strip port connector configured to connect to the respective electrode connectors of the test strip; and
a microprocessor in electrical communication with the test strip port connector to apply electrical signals or sense electrical signals from the plurality of electrodes during a test sequence to provide for an analyte measurement, the microprocessor is configured to: (a) store a most recent analyte measurement and a prior analyte measurement within a predetermined time interval between the most recent and prior measurements, (b) determine if a difference between the most recent and prior analyte measurements is within a predetermined threshold, indicate that the results are within expected accuracy; or (c) if the difference is greater than the predetermined threshold, request the user to conduct another test.

9. The meter of claim 8, in which the predetermined threshold is selected from a group consisting essentially of percent error between the most recent and prior measurements of about 10%, 15%, 20%, 25%, 30% or about 40%.

10. The meter of claim 8, in which the predetermined threshold is selected from a group consisting essentially of a differential between the two measurements of about 10 mg/dL, 15 mg/dL, 20 mg/dL, 25 mg/dL, or 30 mg/dL.
